(19) United States
(12) Patent Application Publication
(10) Pub. No.: US 2006/0076402 A1
(43) Pub. Date: Apr. 13, 2006

(54) Method for authorizing an auxiliary account using identification wristbands

(75) Inventors: John W. Lerch, Indialantic, FL (US); Joshua M. Girvin, Indialantic, FL (US)

Correspondence Address: EDWARDS & ANGELL, LLP, P.O. BOX 55874, BOSTON, MA, 02205, US

(73) Assignee: Proximities, Inc., Melbourne, FL (US)

(21) Appl. No.: 11/246,358

(22) Filed: Oct. 7, 2005

Related U.S. Application Data
(60) Provisional application No. 60/617,518, filed on Oct. 8, 2004.

(51) Int. Cl. G06Q 40/00; G06K 5/00

(52) U.S. Cl. 235/380; 705/44

(57) ABSTRACT

A process for electronic authorization to access a common account via personal identification devices such as Radio Frequency Identification (RFID) tags, such as may be mounted on a wristband. RFID wristbands for auxiliary users are not authorized by a cashier/operator unless a primary account holder's RFID wristband is utilized as an immediate preceding step. This process alleviates a problem with simpler approaches which merely require operator authorization to associate auxiliary RFID wristbands with primary RFID wristbands.

### CROSS-REFERENCE TO RELATED APPLICATIONS

This application claims the benefit of U.S. Provisional Application No. 60/617,518 entitled “Identification Wristband Concepts”, filed on Oct. 8, 2004. The entire teachings of the above application are incorporated herein by reference.

### BACKGROUND OF THE INVENTION

The present invention relates to automated transaction systems, and in particular to cashless payment systems in which charge account authorization is given to the user of a coded identification wristband or similar device.

It has of course been most common for hundreds of years to exchange cash for goods and services. In the past fifty years or so, credit cards have become engrained in modern society as the most common way for purchasing on credit. Cash or credit cards are now considered to be the most convenient way to pay for transactions in most environments.

However, there are certain locations where credit cards and/or even cash cannot be easily carried and actually end up becoming a hindrance to rapid service. These locations may include amusement parks, water parks, sporting events, concerts, night clubs, ski resorts, vacation destinations, cruise ships, and similar venues where large numbers of many people may queue for service. Within these locations the number of monetary transactions for not only initial entry but subsequent purchase of food, souvenirs, gifts, access rides and/or special attractions, or other areas becomes tremendously time consuming. Time spending standing in line deprives patrons of time they would otherwise use to enjoy the venue for which they have often paid a good deal of money.

Systems that make use of personal identification (ID) tags have been developed in an effort to reduce delays in such venues. At an entry location or other convenient spot, a patron (guest) is issued a Radio Frequency Identification (RFID) tag. The RFID tag is typically mounted on a wristband fastened around the patron's wrist, or on a badge designed to be clipped to one's clothing. (We will discuss RFID wristbands herein with the understanding that the RFID tag may be carried on the person in other ways.) In an initial transaction, the guest obtains monetary credits either by cash or credit card for later transactions. The guest's credit card information and the serial number of the RFID wristband are then associated with one another within a local transaction data processing system. Thus, a subsequent purchase can be made by the patron merely presenting the RFID wristband.

One such system is described in U.S. Patent Publication 2002/0070865 where a number of self-service kiosks are strategically placed such as throughout an amusement park. During the initial authorization phase, this system also permits a guest to be considered the primary user of a “group” account, and enable others to share the use of his credit card account.

In one approach to authorizing additional members of the group, an operator of a service terminal issues multiple RFID tags for each of several guests in the same group. All of the RFID tags in the same group are then associated with the primary user's charge card.

This system also permits a guest to operate a self-service kiosk to himself authorize additional RFID tags in the same group. The kiosk has a computer system that requests the guest to place his RFID tag approximate to an RFID reader. The kiosk system then prompts the user to enter a password prior to authorizing issuance of a new group RFID tag.

### BRIEF SUMMARY OF THE INVENTION

These known systems work to the extent that they allow the association of RFID tags used by different people to a common account. This can be of particular usefulness when members of the same family wish to have their charges all be made to one common credit card.

However the approach used to date can be easily abused, by personnel of the venue, or any one else who is not the credit card holder, but who may have the authority to operate the terminal systems that authorize RFID wristbands for auxiliary accounts. In particular, once an operator has the primary patron's credit card information, it is a simple matter to authorize not only the requested number of RFID wristbands for group members, but to also authorize additional wristbands unbeknownst to the credit card holder. This creates a problem in that untrustworthy operators can authorize additional wristbands without the explicit knowledge of the patron.

The present invention seeks to alleviate this difficulty by requiring a particular process to be followed each time that electronic authorization to access a common account is requested. In this approach the auxiliary RFID wristbands in a group are not allowed to be authorized unless the primary account holder's RFID wristband is first scanned as an immediate preceding step. Thus an auxiliary RFID wristband is authorized if and only if an associated primary band is scanned and authenticated immediately prior to authorizing the auxiliary band.

This process alleviates a problem with simpler approaches which for example merely require operator authorization to associate auxiliary RFID wristbands with primary RFID wristbands. Employee theft is thus reduced, because with the invention, the user of the primary band (who is most likely the owner of the credit card) must be physically present at any time an operator attempts to authorize an auxiliary RFID band.

The attributes of authorized auxiliary account users may include additional options. For example, one can indicate whether or not the exact same credit card is to be used for the auxiliary account or a different one, one can assign spending limits to the use of the auxiliary account, one can attach purchase restrictions such as a restriction the purchase of alcoholic beverages, or one can attach other personalization features to the auxiliary user that may be desirable for a second account class.

These personalization features may typically depend upon a particular venue. For example, other personalization features that might be used in an amusement park include indicating whether access to certain rides as limited by age is to be associated with such auxiliary account holders.

The present invention thus avoids a problem with prior systems where general authorization of a group of wristbands to a common account can be accomplished by an employee without having the primary account holder present.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a general schematic diagram showing a system in which transactions may be entered into and identification wristbands associated with various accounts according to the present invention.

FIG. 2 is a block diagram of a wristband authorization terminal.

FIG. 3 is a plan view of a RFID wristband which may be used with present invention.

FIG. 4 is a flowchart of steps used to authorize a primary account.

FIG. 5 is a flowchart of steps used to refuse authorization for a secondary or auxiliary account according to the present invention.

### DETAILED DESCRIPTION OF THE INVENTION

A description of preferred embodiments of the invention follows.

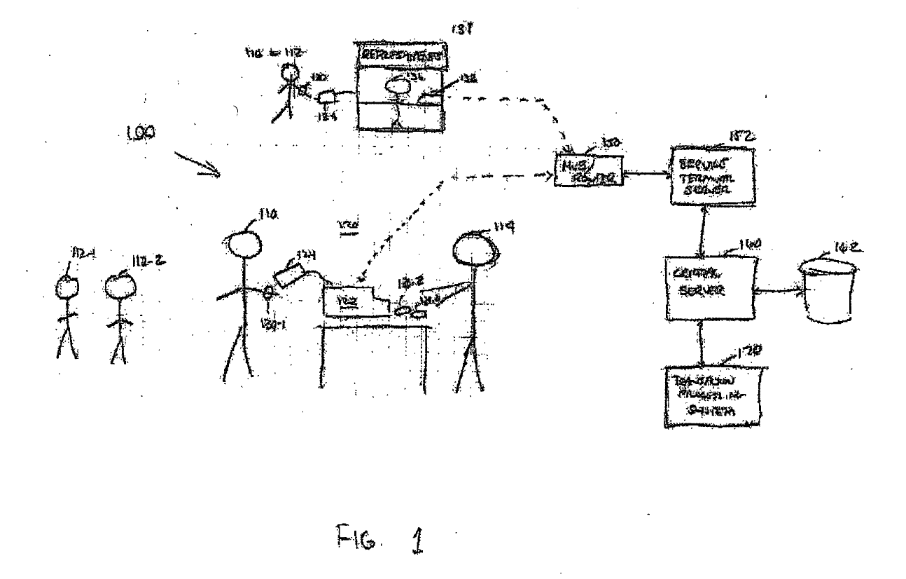

FIG. 1 is a high level schematic diagram of a system 100 which may be used to grant and share authorization to access a common credit account. Using the system 100, patrons such as a primary patron 110 and auxiliary patrons 112-1, 112-2 (collectively auxiliary patrons 112) may be issued personal identification devices such as Radio Frequency Identification (RFID) bracelets 130. As described in detail below, after an authorization procedure is completed, the RFID bracelets 130 may then be used by patrons 110, 112 to engage in transactions such as to purchase soft drinks at a refreshment stand 131.

The particular authorization procedure of interest to the present invention requires the involvement of an operator 114. The operator acts as an attendant or cashier at a point of sale terminal 122 at a point of sale location 120. While FIG. 1 shows the terminal 122 to be at a fixed location it should be understood that a portable handheld terminal could also be used. The location 120 may for example be at or near an entrance to a venue in which many people are expected to engage in transactions such as a sporting event, concert, amusement park, shopping mall, fair, trade show, ski resort, vacation destination, or other such locations.

In accordance with aspects of the invention, the operator 114 must follow a certain process after authorizing primary wristband 130-1 used by the primary account user 100 in order to authorize auxiliary wristbands 130-2 to be used by the auxiliary account users 112. Failure to do so renders any attempt to authorize auxiliary wristbands 130 impossible.

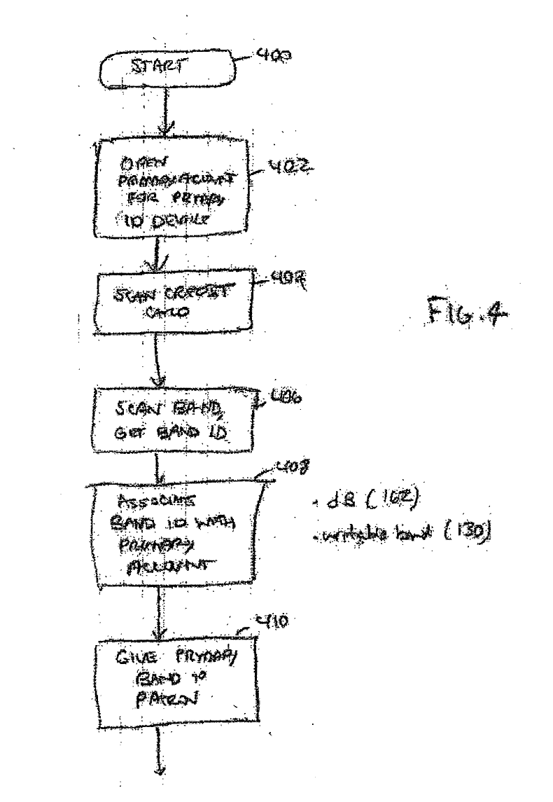

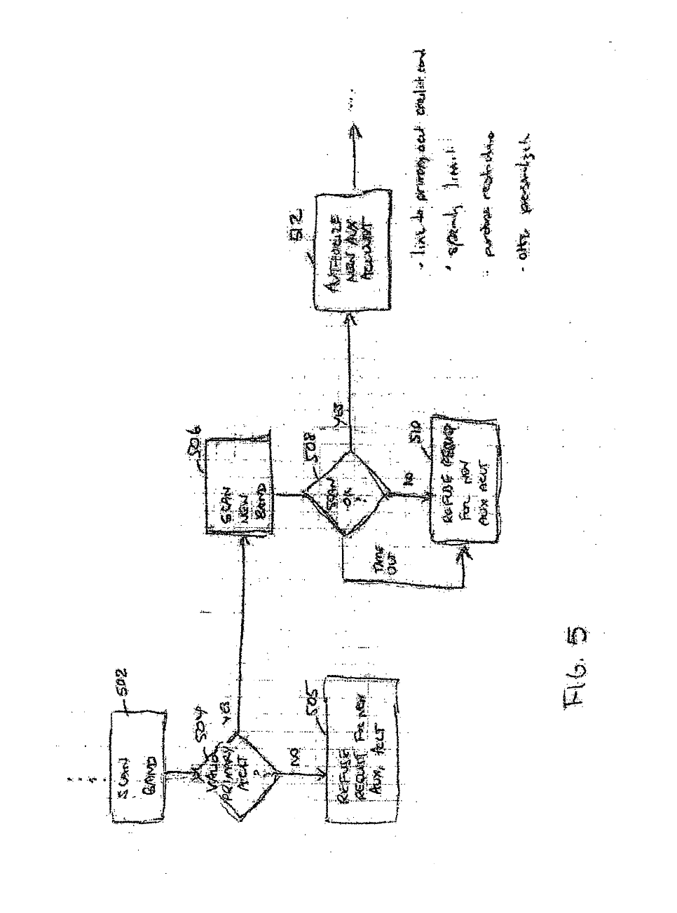

A processing system, communicating with point of sale terminal 122, includes a hub 150, a service terminal server 152, a central server 160 and/or transaction processing system 170, and database 162. All of these data processing devices may be interconnected by various types of wired and/or wireless computer networks. During authorization, operator 114 uses point of sale terminal 122 by entering data via a keypad thereon, using a credit card reader (not shown in FIG. 1) and an RFID reader/writer 124 to read and/or write information to wristbands 130 and/or central server 160. As part of authorizing an initial primary wristband 130-1, data is sent from the point of sale terminal 122 through various data networking systems to hub 150. Details of the preferred method for authorizing wristbands 130-1, 130-2 are described herein in detail in connection with FIG. 4 and FIG. 5.

After authorization, patrons 110 and/or 112 may then use their wristbands 130 for purchases. For example, at a location such as a refreshment stand 131 operated by another attendant 136, a reader 134 reads serial number or other identification information stored on wristband 130. This enables a point of sale terminal 132, communicating with hub 150, to access central server 160 and ultimately transaction processing system 170 to authorize the transaction such as the purchase of refreshment requested by patron 110 and/or 112.

While the wristbands 130 are described herein as RFID wristbands it should be understood that other types of identification devices such as bar coded wristbands printed by laser printers and read by bar code scanner devices could be used. In addition, RFID tags may be attached to or worn by the clothing or a person in many ways, and thus can be adapted to form factors other than a wristband as described in the preferred embodiment herein.

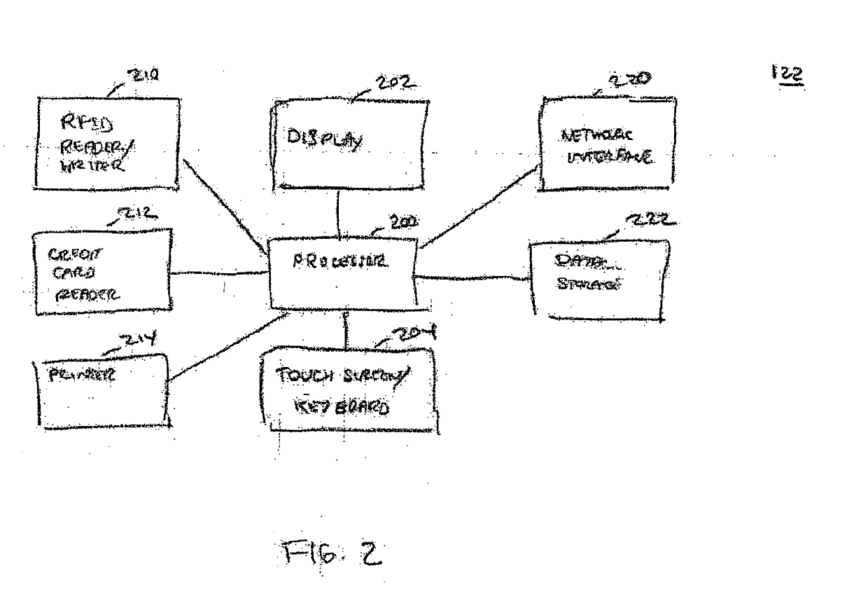

FIG. 2 is a more detailed block diagram of the point of sale terminal 122. It generally has components that are well known in the art such as a central processor 200, a display 202, and a touch screen, keyboard or other input device 204 that permit the operator to enter and read various information from the data processor 200. Preferably, the terminal 122 also has an RFID reader/writer 210 (also labeled 124 and 134 in FIG. 1) a credit card reader 212, and a printer 214. Additional components may include a local data storage 222 and a network interface 220. These components generally operate as is well known in the art to provide the functions of a point of sale terminal such that credit card information may be obtained from the credit card reader 212. Authorization to engage in credit transactions is then obtained via the network interface 220 by access to, or through, central server 160 and/or transaction processing system 170. Authorization being confirmed by various information being presented on the display 202 and/or printed at printer 214.

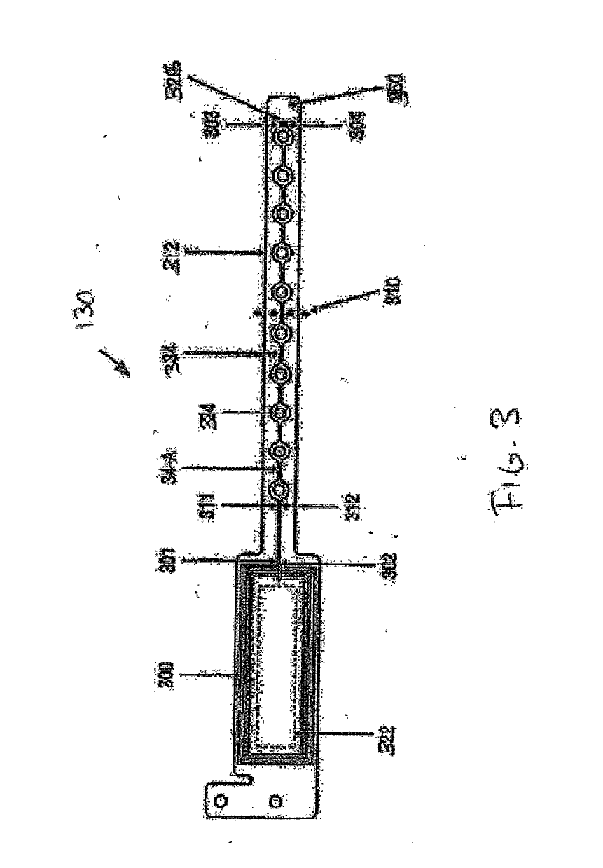

FIG. 3 is a illustration of an RFID wristband 130 that may be used with the present invention. The wristband 130 contain generally elongated strip of material having an RFID integrated circuit (IC) chip 322 thereon. The band of material 312 may be formed of a material such as a Teflon®, or thermoplastic base, and typically has a coiled antenna section 300 disposed at one end thereof. In order to fasten the band 130 around a person's wrist, the distal end 360 is placed through a peg and/or mounting hole on the opposite end of the band, while also engaging through one of the adjustment holes 324. The flap is then folded and the band secured to prevent removal from the wrist until utilization of the device 130 is complete.

With this arrangement, in one non-limiting example, a conductive track 334 also runs from the coiled antenna down to the RFID chip and back around a series of fastening holes 324. The conductive track 334 closely encircles the holes 324 such that any attempt to tamper with the band, stretch the holes to remove the band, and/or cut the band 130 necessarily disables the RFID function. More details of such a wristband can be found in co-pending U.S. patent application Ser. No. 10/400,049 on Mar. 26, 2003 by Girvin, J., and Lerch, J., entitled “Non-Reusable Identification Device”, assigned to Proximities, Inc., the assignee of the present application, which is incorporated herein in its entirety.

FIG. 4 shows a more detailed flowchart of a process for authorizing an initial primary account wristband 130-1. With reference now to FIG. 4 and to certain elements of FIG. 1, from an initial starting step 400, in a step 402, a state is entered in which a primary account is to be opened for a primary RFID wristband 130-1. This is done in step 404 by first scanning the patron's 110 credit card at terminal 122. Next an available RFID wristband 130-1 is handed to the primary patron 110 with the patron then fastening the band 130-1 around the wrist or other body part of patron 110 or the primary patron's designee. At this point the band, in a step 406, is scanned by using scanner 124 to read its stored identification information such as a serial number.

In step 408 the RFID identification information read from the RFID band 130-1 is associated with the primary patron's 110 credit card data and stored as an account data object. The account data object is also identified as a primary account. The account data object that associates the wristband serial number with the primary credit card account information can be done by creating a record in the database 162 associated with server 160. Alternatively, at least some or all of this association information such as credit card number, serial number, or even a PIN (Personal Identification Number) can be provided on the band 130-1 itself by reader/writer 124 if it is of the type that has a writable RFID chip.

After obtaining authorization for his own band 130-1, the primary account patron 110 will then wish to authorize use of his account by other auxiliary patrons 112. For example, the primary patron 110 may wish to authorize auxiliary users 112 such as may be the children, spouse, or friends of the primary account patron 110. According to the present invention, a process will be performed by the primary patron 110, interacting with the RFID reader/writer 124 in a particular way with coordination by the operator 114 of terminal 122, whereby a primary band 130-1 associated with the primary account is first scanned. If this does not happen, then system 100 does not permit further authorization for auxiliary accounts.

The process shown in FIG. 5 is one example of a process according to one embodiment of the present invention that provides this advantage. In this process, the band of the primary account holder 110 must first be scanned by reader/writer 124 in a step 502. In step 504 it is next and immediately determined if this band is associated with a valid primary account data object. If not, then a state is immediately entered, in step 505, wherein any subsequent request to authorize auxiliary accounts will be denied.

If, however, in step 504 a valid primary account band 130-1 has been scanned then in a step 506 an additional band 130-2 is scanned. Optionally, the primary account patron 110 may be asked to select the option of authorizing an auxiliary account holder before proceeding to step 506. In a step 508, it is determined whether a scan is valid. If it is determined in step 508 that the scan is not successful, i.e., if the additional band 130-2 is not recognized by reader/writer 124, then any request for authorizing use of band 130-2 as an auxiliary account will be refused in a step 510. Alternatively, a retry option may be provided to band 130-2, such that it may be rescanned by reader/writer 124 one or several times before it is finally refused.

In an exemplary, non-limiting embodiment, central server 160 includes a clock for measuring time intervals. Authorization cannot occur after a time out period at this point. In particular, after a predetermined time out period (which may be as small as 10 or 15 seconds), if the identification information (i.e., serial number) of the new band 130-2 is not read, then any subsequent requests for associating the new band 130-2 as an auxiliary account of the primary patron's 110 account will be refused in a step 510.

If, however, in step 508 the scan of the secondary band 130-2 is successful, valid, and timely, then the additional band 130-2, in step 512, will be authorized to engage in transactions as an auxiliary account associated with the primary account. An auxiliary account data object can thus be created in a manner similar to the primary account data object, such that an association is made between the serial number of the new wristband 130-2 and the credit card number of the primary patron 110. Furthermore, any information such as primary account information, or auxiliary account limitations, as discussed below, may be stored on wristband 130-2.

By providing the pertinent account information on respective wristbands 130-1-130-N, a de facto portable database is provided. Therefore, point of sale terminals 122, 132 may now be enabled to conduct transactions independently of each other or without communication with hub router 150. It should also be understood from the above, that each of terminals 122, 132 may be networked with each other, as shown in FIG. 1, or may include all or a portion of the functionality provided by server terminal 152, central server 160, and terminal processing system 120, so that all that is required is a simplified communication network among point of sale terminals 122, 132. This distribution of functionality may also be incorporated as a master/slave terminal arrangement in which, by way of example, all of the functionality is provided at a single terminal server such as 122 communicating with slave terminal 132 which only includes read/write and communication functionality.

The process thus described in FIG. 5 permits authorization of additional wristband 130-2 to access as an auxiliary account user if, and only if, the primary account holder's wristband 130-1 is scanned immediately prior to additional band 130-2 being scanned, i.e., step 504 is followed by step 506. Immediately means without either a time interruption (timed out) or intervening scan. With this process, the owner or user of the primary band 130-1 must always be physically present at the reader/writer 124 at the same time as the intended user 112-1 of the auxiliary band 130-2 is present. Without such presence of both patrons, any auxiliary bands 130-2, 130-3 will not be authorized.

This process thus avoids unauthorized use of auxiliary accounts by personnel such as cashiers 114, 136 of the establishment. With the invention, even though personnel 114 may capture and/or record the credit card number of the primary patron 110, it then becomes impossible for them to authorize auxiliary wristbands 130-2 without the physical presence of patron 110 and/or band 130-1. In this manner the invention is actually more secure than other transaction processing systems where anyone in possession of a valid credit card number may make charges.

In connection with step 512, authorization of an auxiliary account can further include additional information accepted by the operator 114, and recorded in the data object associated with the auxiliary account stored in database 162. This additional information may be used to indicate confirmation that the auxiliary account should be associated with the same credit card as the primary account and/or possibly a different credit card number.

It can also be used for other things, such as to assign spending limits to the user of the auxiliary account. If an auxiliary wristband 130-2 is to be used by a child for example one may set purchase limits on refreshments to a predetermined amount.

Other auxiliary account personalization features may include purchase restrictions, such as may include refusing the use of auxiliary bands 130-N by users 112-N to purchase of alcoholic beverages.

In other venues, such as at an amusement parks, the auxiliary band may store age information, and can thus be used to easily identify underage small children that need to be prevented from gaining access to rides or other attractions intended only for adults.

Other personalization features may be supported depending upon what is desirable for the second class of users, again which typically depend upon attributes of a particular venue.

While this invention has been particularly shown and described with references to preferred embodiments thereof, it will be understood by those skilled in the art that various changes in form and details may be made therein without departing from the scope of the invention encompassed by the appended claims.

What is claimed as new and desired to be protected by Letters Patent of the United States is:

1. A method for authorizing transactions using personal identification devices comprising the steps of:
(a) authorizing a first identification device to access a primary account, the first identification device containing a first set of identification information;
(b) at a later time reading the first set of identification information from the first identification device;
(c) immediately thereafter, reading a second set of identification information from a second identification device; and
(d) authorizing the second identification device to access the primary account only if step (c) immediately follows step (b).

2. The method of claim 1 wherein at least a portion of the first set of identification information of the first identification device is stored in one of (i) the second identification device and (ii) an external database.

3. The method of claim 1 wherein the identification information includes at least one of a credit card number, a serial number, and a PIN number.

4. The method of claims 1 wherein the first and second identification devices are Radio Frequency Identification (RFID) tags.

5. The method of claim 4 wherein the RFID tags are mounted on wristbands.

6. The method of claim 1 wherein step (d) authorizes the second identification device if steps (b) and (c) occurred within a predetermined time interval.

7. The method of claim 1 wherein a person using the first identification device and a person using the second identification device must be physically present at a single location for at least steps (b) and (c).

8. The method of claim 1 additionally comprising:
associating additional information with the second device selected from the group consisting of associated primary credit card information, a spending limit, an age restriction, an area access restriction.

9. The method of claim 1 wherein step (d) authorizes the second identification device if steps (b) and (c) are performed in uninterrupted succession.

10. The method of claim 1 wherein steps (b), (c), and (d) are performed under administration by an authorized operator.

11. The method of claim 10 wherein the operator is a person using the first identification device.
